(19) United States
(12) Patent Application Publication
(10) Pub. No.: US 2017/0184468 A1
(43) Pub. Date: Jun. 29, 2017

(54) SENSOR FOR DETECTING A PRESSURE OF A FLUID MEDIUM

(71) Applicant: Robert Bosch GmbH, Stuttgart (DE)

(72) Inventors: Falk Rueth, Filderstadt (DE); Oliver Stoll, Kirchheim-Teck (DE)

(21) Appl. No.: 15/382,909

(22) Filed: Dec. 19, 2016

(30) Foreign Application Priority Data
Dec. 23, 2015 (DE) 102015226642.7

(51) Int. Cl. G01L 19/00; G01L 9/00; G01L 19/14

(52) U.S. Cl. CPC G01L 19/0038; G01L 19/14; G01L 9/0052

(57) ABSTRACT

A sensor for detecting a pressure of a fluid medium is provided. The sensor includes a sensor element for detecting the pressure of the fluid medium, a supply duct for supplying the fluid medium to the sensor element and a control and/or evaluation circuit for processing signals of the sensor element. The control and/or evaluation circuit is situated on the sensor element.

### CROSS REFERENCE

The present application claims the benefit under 35 U.S.C. §119 of German Patent Application No. DE 102015226642.7 filed on Dec. 23, 2015, which is expressly incorporated herein by reference in its entirety.

### BACKGROUND INFORMATION

In various areas of technology, for example in the natural sciences and in medical technology, it is necessary to detect one or multiple properties of fluid media. One of these properties is the pressure of fluid media, that is, of gases and/or liquids.

One important example, to which the present invention is not restricted, however, is the detection of a pressure of fluid media in the area of motor vehicles. Such pressure sensors are described, for example, in Konrad Reif (Ed.): Sensoren im Kraftfahrzeug [Sensors in Motor Vehicles], 1st Ed. 2010, pages 134-136.

Pressure sensors for automotive applications are based on so-called silicon sensing technology, i.e., on the application of a silicon chip as a sensor element having a deformable diaphragm, the deformation of the diaphragm being a measure for the pressure. Conventional sensor elements may have an integrated analog evaluation circuit. Conventional sensor elements may also be provided with the control and/or evaluation circuit separately.

German Patent Application No. DE 199 29 028 A1 describes a pressure sensor having a sensor element, on the back side of which a cap is situated, a cavity being formed between the inner side of the cap and an upper side of the sensor element, which acts as a reference chamber for pressure measurement. The sensor element in turn is electrically connected via bonding wires to contact sections of a separately provided leadframe.

In spite of the improvements effected by the pressure sensors described above, there continues to exist an optimization potential. Thus, although it is possible to minimize the installation space in sensor elements having an integrated analog evaluation circuit, it is necessary in this case to adapt the analog circuit for each variant of the sensor element. A digital evaluation and output of the pressure signal is not possible. When providing the sensor element and the evaluation circuit separately, it is possible to use different evaluation circuits for different sensor elements. It is thus possible for development and production to occur independently of each other. Digital and analog evaluation circuits are fundamentally possible. Nevertheless, additional installation space is required for the evaluation circuit, for example on a circuit board. In addition, the electrical outputs and inputs of the evaluation circuit must be connected to the sensor element. Additional costs for manufacturing arise in the case of the sensor element having a cap attached on it.

### SUMMARY

A sensor for detecting a pressure of a fluid medium is provided, which avoids the disadvantages of known sensor at least to a large extent and which is able to be manufactured in particular in a compact manner using little installation space and in a cost-effective manner.

A sensor according to the present invention for detecting a pressure of a fluid medium includes a sensor element for detecting the pressure of the fluid medium, a supply duct for supplying the fluid medium to the sensor element and a control and/or evaluation circuit for processing signals of the sensor element. The control and/or evaluation circuit is in this instance situated on the sensor element. In other words, a stack-shaped structure of sensor element and control and/or evaluation circuit of the pressure sensor is provided. Such a vertical arrangement of sensor element and control and/or evaluation circuit saves installation space on a circuit substrate. This makes it possible to achieve a smaller width across flats especially in the case of sensors that are screwed in.

The control and/or evaluation circuit may be situated directly on the sensor element. In other words, no additional components of the pressure sensor are situated between the control and/or evaluation circuit and the sensor element, with the exception of joining means for joining the mentioned components such as adhesive for example, which are required for fastening the control and/or evaluation circuit on the sensor element. This further minimizes the required installation space.

The control and/or evaluation circuit may be situated on the sensor element in such a way that the control and/or evaluation circuit together with the sensor element encloses a cavity. This may be achieved for example in that the control and/or evaluation circuit has on a front side facing the sensor element a recess, the recess being closed by the sensor element for forming the cavity. This cavity thus forms a reference volume. If this is designed to be subject to vacuum pressure, then a pressure sensor for detecting absolute pressures of the fluid medium may be implemented in a simple manner, and accordingly the present invention is able to implement absolute pressure sensors quasi on its own without additional costs by stacking the sensor element and the control and/or evaluation circuit.

The control and/or evaluation circuit is preferably situated on a back side of the sensor element facing away from the supply duct. This illustrates the stack-shaped structure.

The sensor element and the control and/or evaluation circuit may be situated in a direction of longitudinal extension. A cross-sectional area of the control and/or evaluation circuit perpendicular to the direction of longitudinal extension may be smaller than a cross-sectional area of the sensor element perpendicular to the direction of longitudinal extension. This creates room for electrical components that are required for electrically connecting the control and/or evaluation circuit to the sensor element. Thus, for example, at least one connection contact may be situated on the back side of the sensor element. The control and/or evaluation circuit may be electrically connected to the sensor element for example by using a bonding wire to connect control and/or evaluation circuit electrically to the connection contact. With respect to the direction of longitudinal extension, the connection contact may be situated next to the control and/or evaluation circuit and thus outside of the cavity described above.

The sensor element may be a silicon chip for example. Such a silicon chip is normally developed in such a way that a measuring bridge is provided on its back side, i.e., on one of the surfaces, which measuring bridge may be developed for example in the form of a Wheatstone bridge from piezoresistive resistor element. The diaphragm required for detecting the pressure may be produced by etching the front side facing away from the resistor elements.

In the context of the present invention, a control and/or evaluation circuit is to be understood as a component suited for signal processing. For example, the control and/or evaluation circuit may be an application-specific integrated circuit (ASIC). A circuit of this kind is an electronic circuit that is implemented as an integrated circuit.

A circuit substrate is to be understood in the context of the present invention as any component suited to support a circuit. The circuit substrate is developed as a circuit board for example. In the context of the present invention, a circuit board is to be understood as a support for electronic components for mechanically fastening the electrical connection. The circuit boards are made of electrically insulating material having conductive connections adhering thereto, which are known as circuit traces. The present invention provides for the control and/or evaluation circuit not to be situated directly on the circuit substrate, but rather for the circuit substrate to be situated separately. For this purpose, an electrical connection of the control and/or evaluation circuit to the circuit substrate is provided, for example by way of bonding wires.

### BRIEF DESCRIPTION OF THE DRAWING

Additional optional details and features of the present invention result from the following description of preferred exemplary embodiments, which are shown schematically in the figure.

FIG. 1 shows a longitudinal cross section of a sensor according to the present invention.

### DETAILED DESCRIPTION OF EXAMPLE EMBODIMENTS

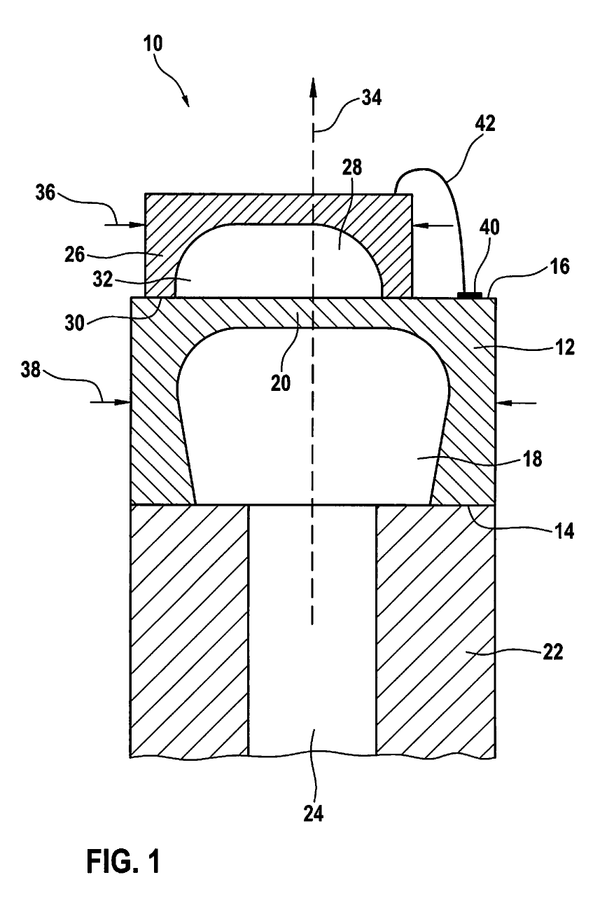

FIG. 1 shows a longitudinal cross section of a sensor 10, according to the present invention, for detecting a pressure of a fluid medium. Sensor 10 may be designed for example for detecting a pressure of fuel in a fuel line of an internal combustion engine or of exhaust gases in the exhaust gas flow of an internal combustion engine. In this instance, only a portion of the components of sensor 10 is depicted. Additional components such as housing, threaded component, housing base, plug connector, for example, are not shown.

Sensor 10 includes a sensor element 12. Sensor element 12 is a silicon chip. Sensor element 12 has a front side 14 and a back side 16. A recess 18 is developed in front side 14. A section of sensor element 12 having a reduced material thickness above recess 18 forms a deformable diaphragm 20. On diaphragm 20 or back side 16, multiple piezoresistive elements (not shown) are situated in the form of a measuring bridge, for example in the form of a Wheatstone bridge.

Sensor element 12 is situated with front side 14 on a base 22, for example a glass base or a plastic base. Sensor element 12 is firmly connected to base 22, for example bonded. A supply duct 24 for supplying the fluid medium to sensor element 12 is developed in base 22. Supply duct 24 is connected to recess 18.

Sensor 10 furthermore includes a control and/or evaluation circuit 26. Control and/or evaluation circuit 26 is an ASIC. Control and/or evaluation circuit 26 is situated on sensor element 12. More precisely, control and/or evaluation circuit 26 is situated on the back side 16 of sensor element 12 facing away from supply duct 24. Control and/or evaluation circuit 26 is in particular situated directly on sensor element 12 and is fastened on the latter, for example by adhesive.

Control and/or evaluation circuit 26 is situated on sensor element 12 in such a way that control and/or evaluation circuit 26 together with sensor element 12 encloses a cavity 28. Cavity 28 is used for example as a reference volume for an absolute pressure measurement. This may be achieved for example in that control and/or evaluation circuit 26 has a recess 32 on a front side 30 facing sensor element 12. Recess 32 is closed by sensor element 12 to form cavity 28.

Accordingly, sensor element 12 and control and/or evaluation circuit 26 are arranged in a longitudinal extension direction 34.

A cross-sectional area 36 of control and/or evaluation circuit 26 perpendicular to longitudinal extension direction 34 is smaller than a cross-sectional area 38 of sensor element 12 perpendicular to longitudinal extension direction 34. In other words, control and/or evaluation circuit 26 is smaller than sensor element 12. This creates room for an electrical connection of control and/or evaluation circuit 26 to sensor element 12. For example, at least one connection contact 40 is situated on the back side 16 of sensor element 12. Control and/or evaluation circuit 26 is in turn electrically connected by way of a bonding wire 42 to connection contact 36 and thus to sensor element 12.

With respect to longitudinal extension direction 34, connection contact 40 is situated next to control and/or evaluation circuit 26 and thus outside of cavity 28.

Control and/or evaluation circuit 26 is furthermore electrically connected to a circuit substrate (not shown), such as a circuit board for example, for example by way of bonding wires. The circuit substrate is situated for example laterally next to control and/or evaluation circuit 26 or sensor element 12. In other words, the circuit substrate maybe situated at a position that is at a distance from control and/or evaluation circuit 26 or sensor element 12 in a direction perpendicular to longitudinal extension direction 34. In this instance, the circuit substrate itself may be oriented perpendicularly to longitudinal extension direction 34 or extend perpendicularly to longitudinal extension direction 34. Alternatively, the circuit substrate may be situated above control and/or evaluation circuit 26. In other words, the circuit substrate maybe situated at a position that is at a distance from control and/or evaluation circuit 26 in a direction parallel to longitudinal extension direction 34. In this instance, the circuit substrate itself may be oriented in parallel to longitudinal extension direction 34 or extend perpendicularly to longitudinal extension direction 34. Alternatively, the circuit substrate may also be situated partially on control and/or evaluation circuit 26. In other words, the circuit substrate may have a section that is situated directly on control and/or evaluation circuit 26 and may be connected to the latter. In this instance, the circuit substrate may be oriented perpendicularly to longitudinal extension direction 34 or extend perpendicularly to longitudinal extension direction 34.

Furthermore, control and/or evaluation circuit 26 and connection contact 40 are protected against corrosion, for example by a gel. The above-described construction, according to the present invention, of sensor 10 is demonstrable particularly after removal of the gel.

What is claimed is:

1. A sensor for detecting a pressure of a fluid medium, comprising:
a sensor element to detect the pressure of the fluid medium;
a supply duct to supply the fluid medium to the sensor element; and
at least one of a control and evaluation circuit, the at least one of the control and evaluation circuit to process signals of the sensor element, wherein the at least one of the control and evaluation circuit is situated on the sensor element.

2. The sensor as recited in claim 1, wherein the at least one of the control and evaluation circuit is situated directly on the sensor element.

3. The sensor as recited in claim 1, wherein the at least one of the control and evaluation circuit is situated on the sensor element in such a way that the at least one of the control and evaluation circuit together with the sensor element encloses a cavity.

4. The sensor as recited in claim 1, wherein the at least one of the control and evaluation circuit has a recess on a front side facing the sensor element, the recess being closed by the sensor element to form the cavity.

5. The sensor as recited in claim 1, wherein the at least one of the control and evaluation circuit is situated on a back side of the sensor element facing away from the supply duct.

6. The sensor as recited claim 1, wherein the sensor element and the at least one of the control and evaluation circuit are arranged in a longitudinal extension direction, a cross-sectional area of the at least one of the control and evaluation circuit perpendicular to longitudinal extension direction being smaller than a cross-sectional area of the sensor element perpendicular to the longitudinal extension direction.

7. The sensor as recited in claim 6, wherein the at least one of the control and evaluation circuit is electrically connected to the sensor element.

8. The sensor as recited in claim 7, wherein at least one connection contact is situated on the back side of the sensor element, the at least one of the control and evaluation circuit being electrically connected to the connection contact by way of at least one bonding wire.

9. The sensor as recited in claim 8, wherein the connection contact with respect to the longitudinal extension direction is located next to the at least one of the control and evaluation circuit.

10. The sensor as recited in claim 1, wherein the sensor element is a silicon chip.
